(19) United States
(12) Patent Application Publication
(10) Pub. No.: US 2013/0055959 A1
(43) Pub. Date: Mar. 7, 2013

(54) PET LITTER BOX

(71) Applicants: David Spectre, Tel Aviv (IL); Tal Kamil, Miramar Michmoret (IL); Iftach Priel, D.N. Harei Yehuda (IL); Caroline Benson, Evanston, IL (US)

(72) Inventors: David Spectre, Tel Aviv (IL); Tal Kamil, Miramar Michmoret (IL); Iftach Priel, D.N. Harei Yehuda (IL); Caroline Benson, Evanston, IL (US)

(21) Appl. No.: 13/224,014

(22) Filed: Sep. 1, 2011

(51) Int. Cl. A01K 29/00

(52) U.S. Cl. 119/165

(57) ABSTRACT

A pet litter box is provided with a simplified, easy-to-clean and easy-to-use configuration, incorporating a monolithically formed shell, having a large front opening, and a slidable, litter-holding drawer received by the shell. The shell is provided with a circumferential groove in its side and rear walls, which is configured to conform to a projecting ridge forming the upper periphery of the drawer, for purposes of guiding and supporting the drawer. A handgrip recess is also provided in an upper edge region of the rear wall of the shell.

### BACKGROUND OF THE INVENTION

1. The Technical Field

The present invention is directed to pet litter boxes, such as those made, marketed and sold, for household use by cats.

2. The Prior Art

Pet litter boxes, such as those made, marketed and sold, for household use by cats, may generally be divided into two categories: open litter boxes and hooded litter boxes.

Open litter boxes are usually constructed in the form of a simple rectangular tray. The sides may be slightly rounded from one end to the other, and the sides may also be vertical, sloped or curved from top to bottom as well. On occasion, there may be a small inwardly overhanging ledge provided to help inhibit ejection of litter and animal waste when the pet is using the litter box. These ledges may be monolithically formed with the tray, or they may be separate pieces that snap on, or simply rest on, an upper ledge of the tray. Open litter boxes may be used with plastic litter pan liners, into which the litter is directly placed, so that when the litter has become soiled, the liner may be lifted bodily from the tray, to facilitate cleaning of the tray.

Hooded litter boxes are typically constructed with two or more components, and may include a bottom tray portion, and a hood or cover that rests on an upper periphery of the bottom tray. The hood or cover may be releasably secured to the bottom tray, for example with tension latches on the hood, that engage with a downwardly projecting edge of the upper periphery of the bottom tray. The hood may typically have a front opening therein (often requiring the pet to make a relatively high step to enter the tray). A carrying handle is frequently provided in the top of the hood.

Open litter boxes benefit from having a low profile, and easy accessibility for the pet. However, the lack of a cover enables odors from the used litter box to spread more easily. Hooded litter boxes help prevent the dissemination of odors, but are more complex to make, typically more expensive than open litter boxes, and are more difficult to locate in a residence due to their higher profile. In addition, they often present challenges to the pet, due to the requirement for a high step to gain entrance, as well as challenges to the owner, in cleaning. Furthermore, the enclosed nature of a hooded litter box can lead to the pet experiencing a trapped or enclosed sensation, rendering them uncomfortable for the pet to use.

It would be desirable to provide a pet litter box which benefits from the respective advantages of both open and hooded litter boxes, without suffering from the disadvantages of each.

These and other desirable characteristics of the present invention will become apparent in light of the present specification, including the claims, and drawings.

### SUMMARY OF THE INVENTION

The present invention comprises a pet litter box having a shell and a litter drawer.

The shell has a top wall, a bottom wall, and two opposing side walls. The top wall of the shell has a front edge region, a rear edge region and opposing side edge regions. The bottom wall of the shell is disposed opposite the top wall, and has a front edge region, a rear edge region and opposing side edge regions. The two opposing side walls of the shell extend between the top wall and the bottom wall of the shell. Each side wall of the shell has a top edge region and a bottom edge region, a front edge region and a rear edge region. Each of the opposing side walls of the shell is connected to a side edge region of the top wall of the shell and a side edge region of the bottom wall of the shell, respectively. Each side wall of the shell further has a rear edge region. The rear wall of the shell has four side edge regions, each side edge region of the rear wall of the shell being connected to one of the rear edge region of the top wall of the shell, the rear edge region of the bottom wall of the shell, and the rear edge regions of the opposing side walls of the shell, respectively.

The shell further has litter drawer guide grooves formed in at least opposing portions of the bottom side edge regions of the opposing side walls of the shell.

The litter drawer has a front wall, a rear wall, a bottom wall, and two opposing side walls. The front wall of the litter drawer has a top edge region, a bottom edge region, and opposing side edge regions. The rear wall of the litter drawer has a top edge region, a bottom edge region, and opposing side edge regions. Each side wall of the drawer having a top edge region, a bottom edge region, a front edge region and a rear edge region.

The opposing side edge regions of the front wall of the litter drawer are connected to respective ones of the front edge regions of the two opposing side walls of the litter drawer. The opposing side edge regions of the rear wall of the litter drawer are connected to respective ones of the rear edge regions of the two opposing side walls of the litter drawer.

The bottom wall of the litter drawer has a front edge region, a rear edge region and two opposing side edge regions. The front edge region of the bottom wall of the litter drawer is connected to the bottom edge region of the front wall of the litter drawer. The rear edge region of the bottom wall of the litter drawer is connected to the bottom edge region of the rear wall of the litter drawer. The opposing side edge regions of the bottom wall of the litter drawer are connected to respective ones of the bottom edge regions of the opposing side walls of the litter drawer.

The litter drawer further has litter drawer guide shoulders, extending outwardly from at least the top edge regions of the two opposing side walls of the litter drawer.

The litter drawer guide shoulders are operably configured to be insertingly received by respective ones of the litter drawer guide grooves of the shell, to enable the litter drawer to be selectively inserted into, retained in, and slidingly withdrawn from, the shell in a guided and stabilized manner.

### BRIEF DESCRIPTION OF THE DRAWINGS

FIG. 1 is a perspective view of the pet litter box according to a preferred embodiment of the invention, showing the litter drawer partially withdrawn from the shell.

FIG. 2 is a rear perspective view of the pet litter box according to the same embodiment of the invention.

FIG. 3 is a front elevation of the pet litter box according to the same embodiment of the invention, showing the litter drawer in position.

FIG. 4 is a rear elevation of the pet litter box according to the same embodiment of the invention.

FIG. 5 is a top plan view of the pet litter box according to the above embodiment of the invention.

FIG. 6 is a side elevation of the pet litter box according to the same embodiment of the invention.

FIG. 7 is an exploded perspective view of the pet little box according to the same preferred embodiment of the invention.

FIG. 8 is a top sectional view of the pet litter box according to an embodiment of the invention, taken along line 8-8 of FIG. 6, from which the drawer has been omitted, and looking in the direction of the arrows.

FIG. 9 is a top sectional view of the pet litter box, according to an alternative embodiment of the invention, taken along line 8-8 of FIG. 6, as shown in broken lines, with the drawer removed.

FIG. 10 is a top perspective view of the pet litter box drawer, according to an alternative embodiment of the invention.

FIG. 11 is a side elevation of the pet litter box according to the alternative embodiment of FIG. 10.

FIG. 12 is a front sectional view of the pet litter box according to the alternative embodiment of FIGS. 10-11, taken along line 12-12 of FIG. 11 and looking in the direction of the arrows.

FIG. 13 is an enlargement of the area 13 indicated in FIG. 12.

### DETAILED DESCRIPTION OF THE INVENTION

While this invention is susceptible of embodiment in many different forms, there are shown and described in the drawings and associated text, at least two specific embodiments, with the understanding that the present disclosure is to be considered an exemplification of the principles of the invention and is not intended to limit the invention to the embodiments illustrated.

The following description and drawings are illustrative and are not to be construed as limiting. Numerous specific details are described herein to provide a thorough understanding of the disclosure. However, in certain instances, well-known or conventional details are not described in order to avoid obscuring the description. References to one, or an, embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

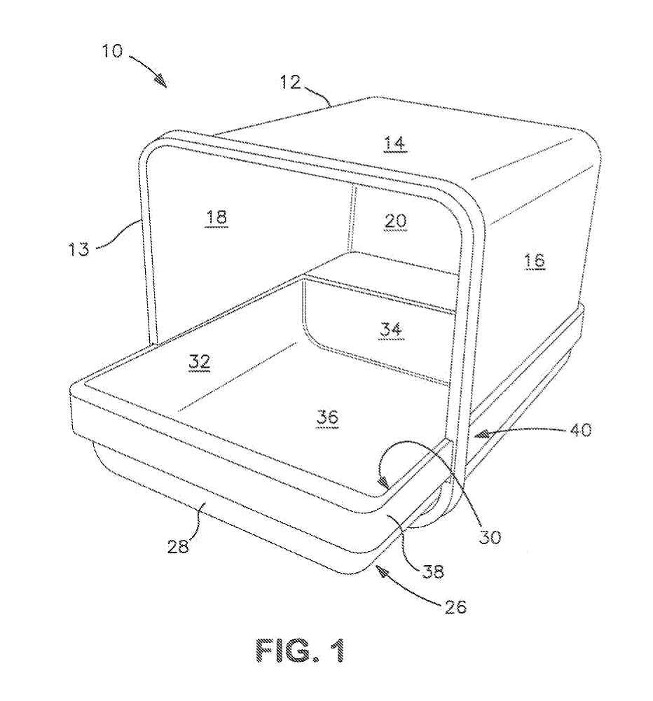

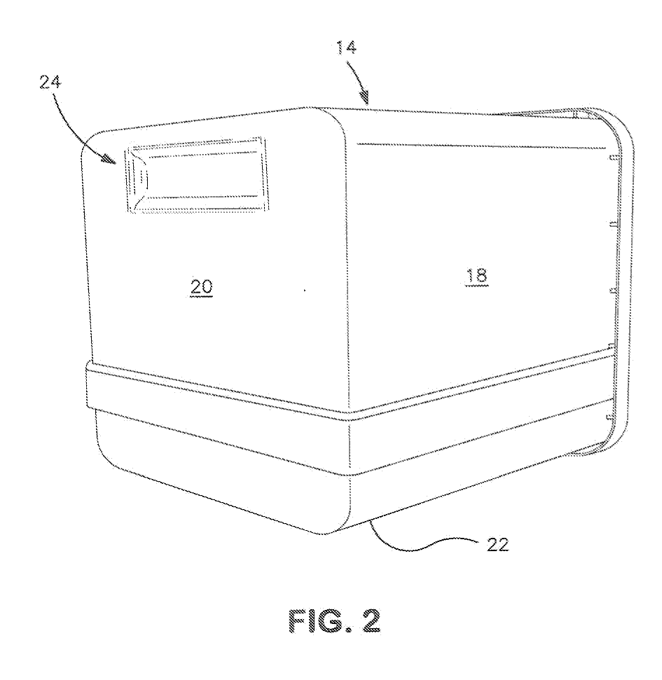

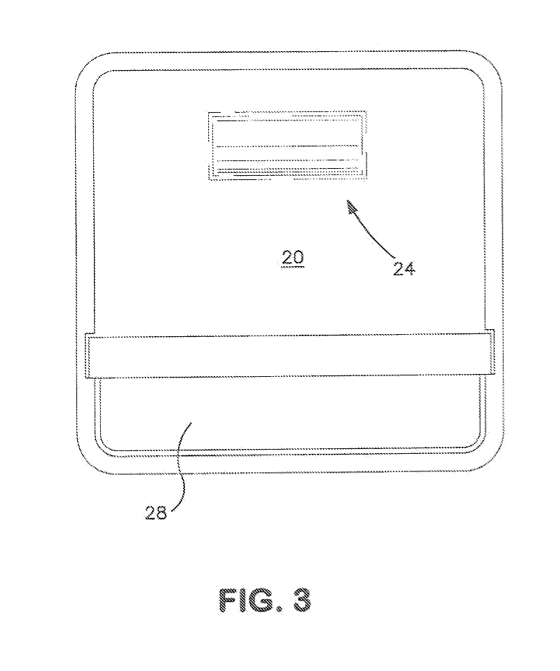

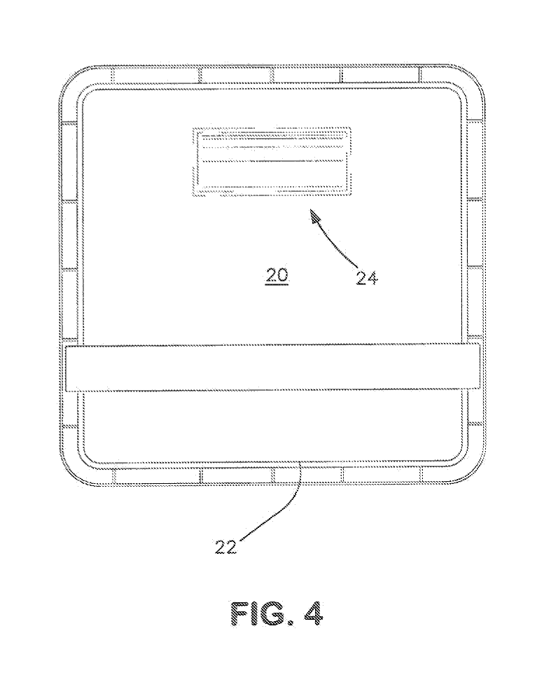

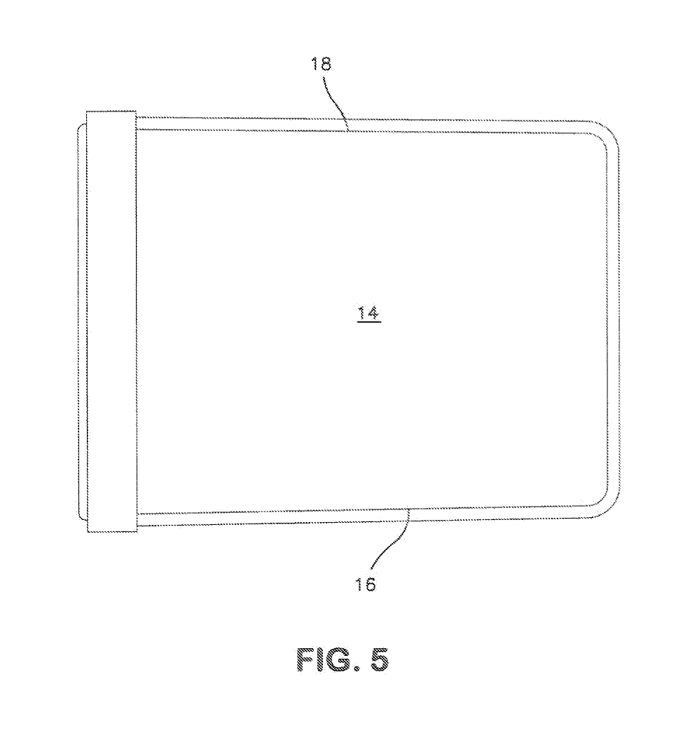

Pet litter box 10, as shown in FIGS. 1-7, comprises shell 12, which is a single piece, which may be monolithically formed, e.g., as a single blow-molded or injection-molded part. Alternatively, it may be formed from two or more components which are then joined together, e.g., by sonic welding or similar technique.

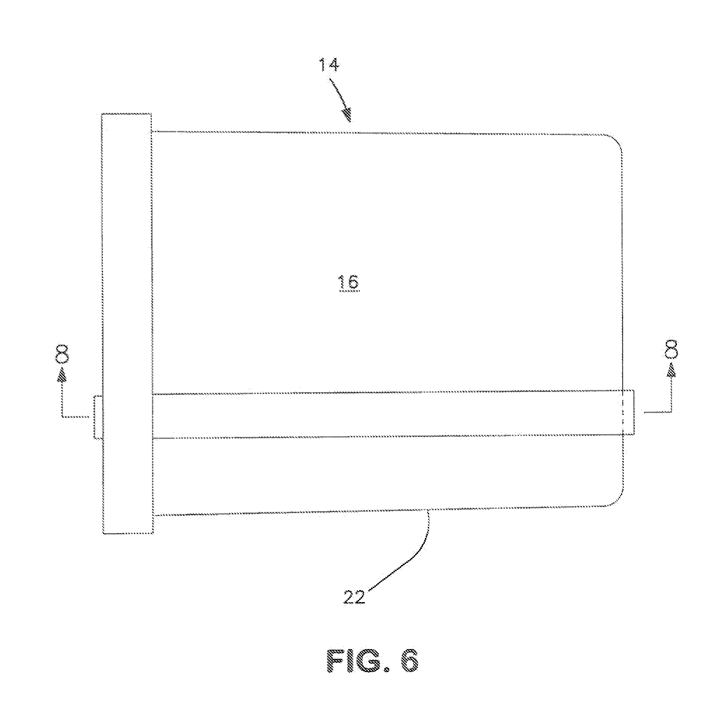

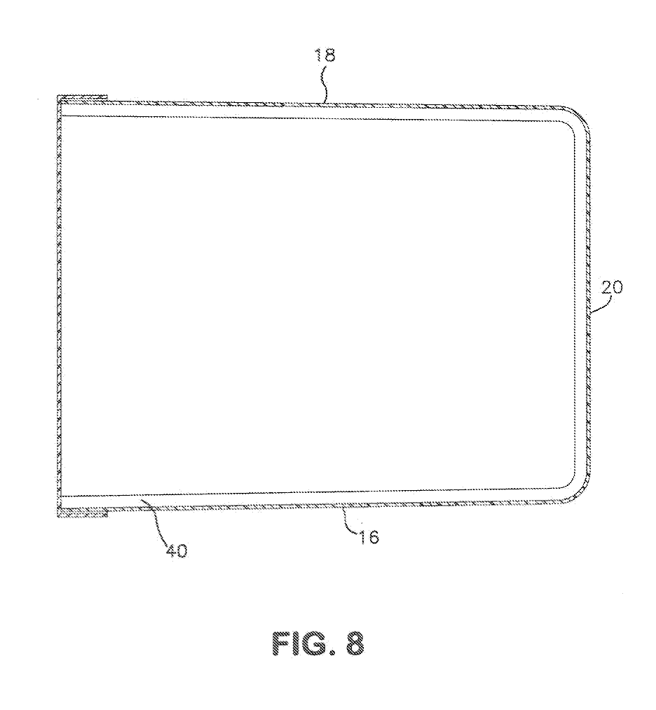

Shell 12 includes top wall 14, right side wall 16, left side wall 18, rear wall 20 and bottom wall 22. Handgrip recess 24 may be formed in an upper portion of rear wall 20, to facilitate handling of pet litter box 10. In a preferred embodiment of the invention, shell 12 is provided with groove 40, which projects outwardly from side walls 16 and 18, as well as back wall 20. Groove 40 is shown in further detail in FIG. 8, which is a top sectional view taken along line 8-8 of FIG. 6, but with drawer 26 omitted for clarity of illustration.

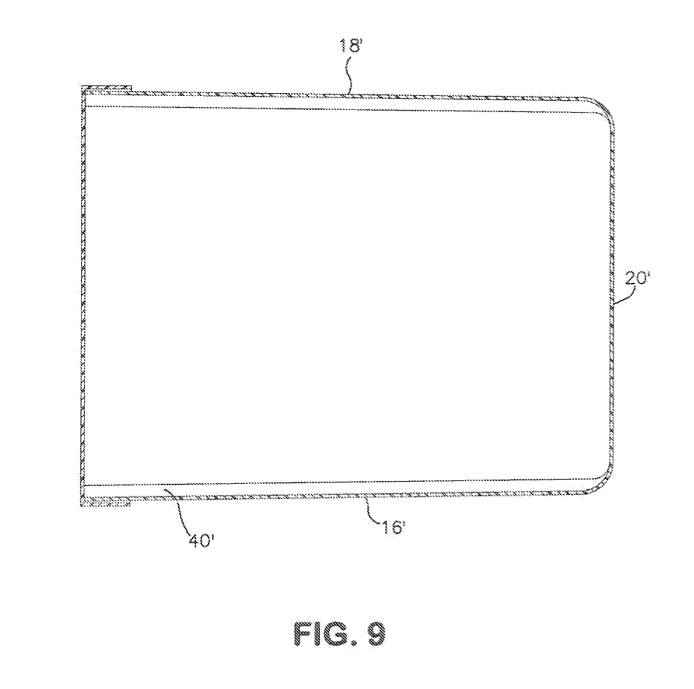

In an alternative embodiment of the invention, shown in FIG. 9, instead of a single groove 40, grooves 40′ are provided solely in side walls 16′ and 18′, and not in back wall 20′. This is reflected in FIG. 6, wherein, in the alternative embodiment of the invention, the groove would not extend across the back wall of the shell, and thus from the side, the back wall of the shell would be a simple vertical wall (as shown in the broken line in FIG. 6). In this alternative embodiment of the invention, there would likewise be no shoulder along the rear wall of the drawer.

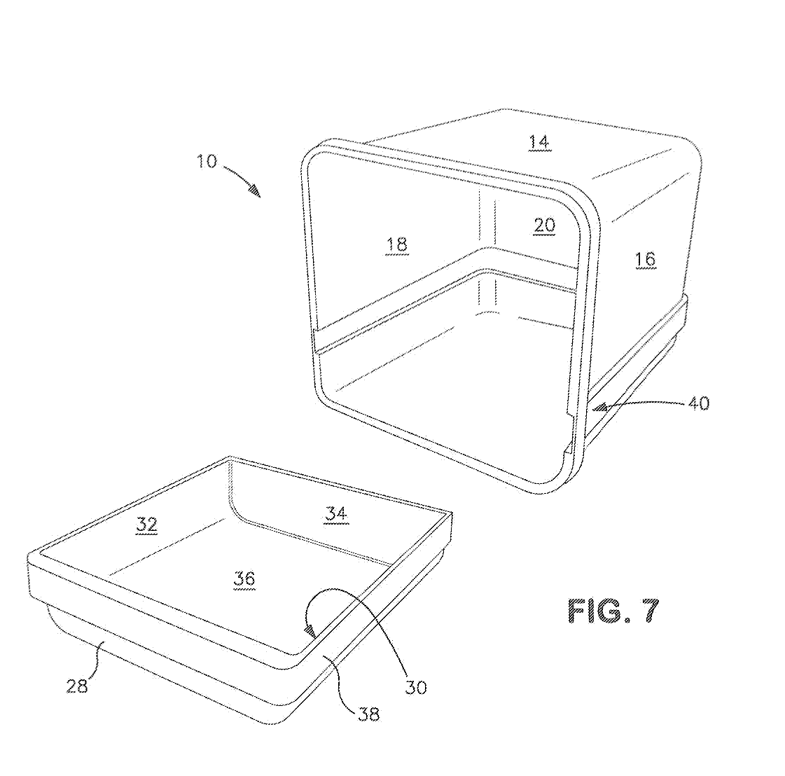

Drawer 26 includes front wall 28, right wall 30, left wall 32, rear wall 34 and bottom wall 36. Shoulder 38, in an embodiment of the invention, shown in FIG. 7, extends around the entire upper periphery of drawer 26.

Shoulder 38 is configured to mate with groove 40 disposed in drawer 26, to create a guide structure, to facilitate the insertion and withdrawal of drawer 26.

In preferred embodiments of the invention, as shown in FIGS. 1 and 7, the corners where bottom wall 36 meets with front wall 28, right wall 30, left wall 32 and rear wall 34 are rounded, to facilitate cleaning.

Shell 12 and drawer 36, in an embodiment of the invention, are preferably fabricated from any suitable moldable plastic material, such as PP (polypropylene), or any similar suitable material. In an embodiment of the invention, the opposing side walls, and the opposing top and bottom walls converge slightly toward one another, when proceeding from the open front to the rear wall. That is, shell 12 is formed with a slight taper from front to back. In an embodiment of the invention, the taper is accomplished by having each of the top, bottom and side walls diverge 2° from the perpendicular, from the front of the shell to the back of the shell, relative to the rear wall. This taper facilitates stacking of the shells, when the pet litter boxes are stored in a commercial retail environment. Drawers 36 will likewise be tapered, but in two dimensions, from the front wall to the rear wall (so that the drawers conform to the contours of the shells they are intended to fit), and from the top edges of the front, rear and side walls, toward the bottom wall (to permit facilitated stacking of the drawers).

The fit between the guide grooves in the side walls of the shell and the guide shoulders in the drawer should be fairly close, so that the drawer is securely received therein, but not so tight as to preclude the placement of a cat litter box liner in the drawer, inasmuch as such liners typically have to be folded out over the edges of the top walls of a cat litter box tray in order to be securely positioned therein.

Due to the fit between groove(s) 40 and shoulder(s) 38, pet litter box 10 is provided with enhanced stability, during the process of inserting and removing drawer 26 from shell 12, in that pivoting or vertical movement of drawer 26, relative to shell 12, is substantially reduced. As a result of this enhanced stability, the likelihood of accidental tipping or flipping of either the drawer or the shell, and subsequent spillage of litter and other materials is reduced.

In embodiments of the invention, shell 12 is provided with a collar 13, which extends along, and is molded integrally with, the front edges of top wall 14, side walls 16 and 18, and bottom wall 22. Collar 13 serves to elevate the front end of pet litter box 10, serving to help keep drawer 26 fully inserted into shell 12, when not being intentionally handled by a pet owner.

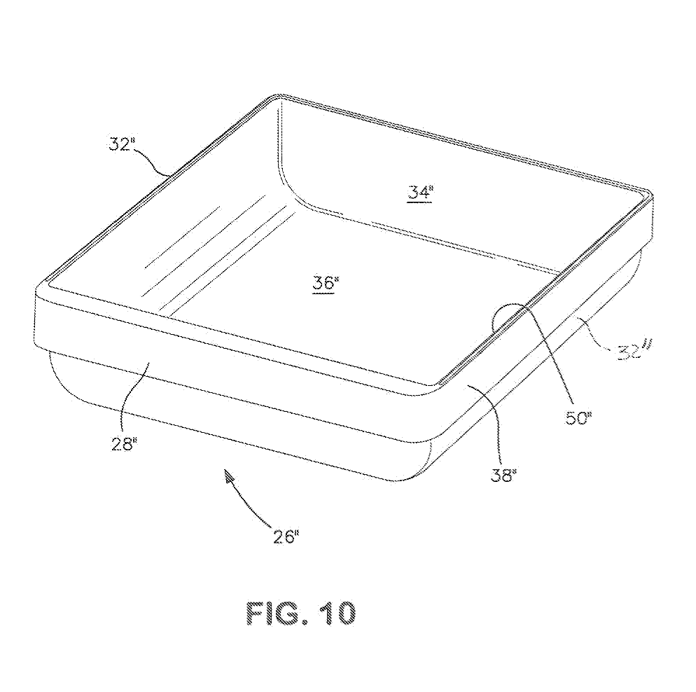

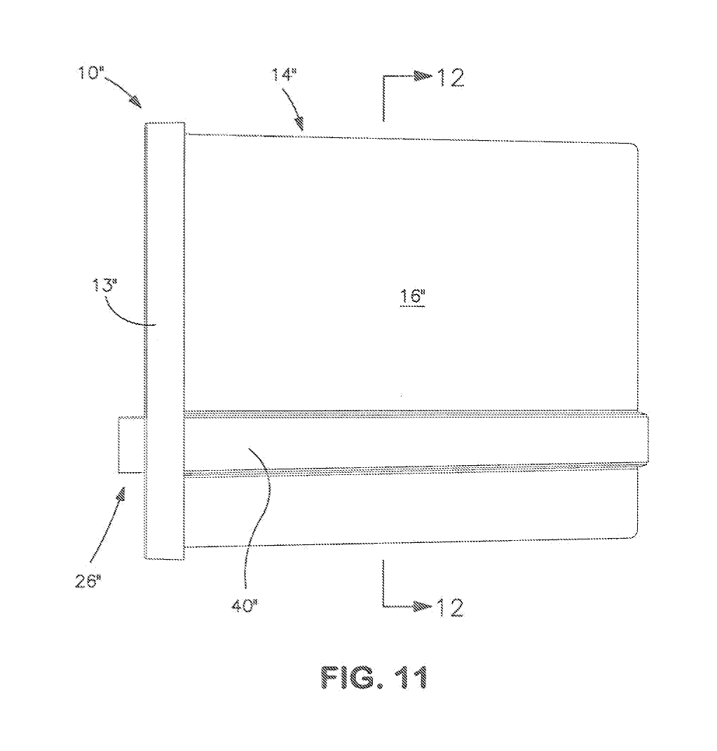

FIGS. 10-13 illustrate an alternative embodiment of the invention which is configured to further inhibit spillage of pet litter material, especially finely-grained litter material, such as scoopable cat litter grains, and other materials, within the pet litter box. To the extent that the embodiment of FIGS. 10-13 has components which are the same as or similar to like-functioning or like-configured components in the previously-described and illustrated embodiments, like structural elements are described and illustrated using like reference numerals designed by a double prime (″).

Pet litter box 10″, as shown in FIGS. 10-13, comprises shell 12″, which, as in the embodiment of FIGS. 1-9, is preferably a single piece, which may be monolithically formed, e.g., as a single blow-molded or injection-molded part. Alternatively, it may be formed from two or more components which are then permanently joined together, e.g., by sonic welding or similar technique.

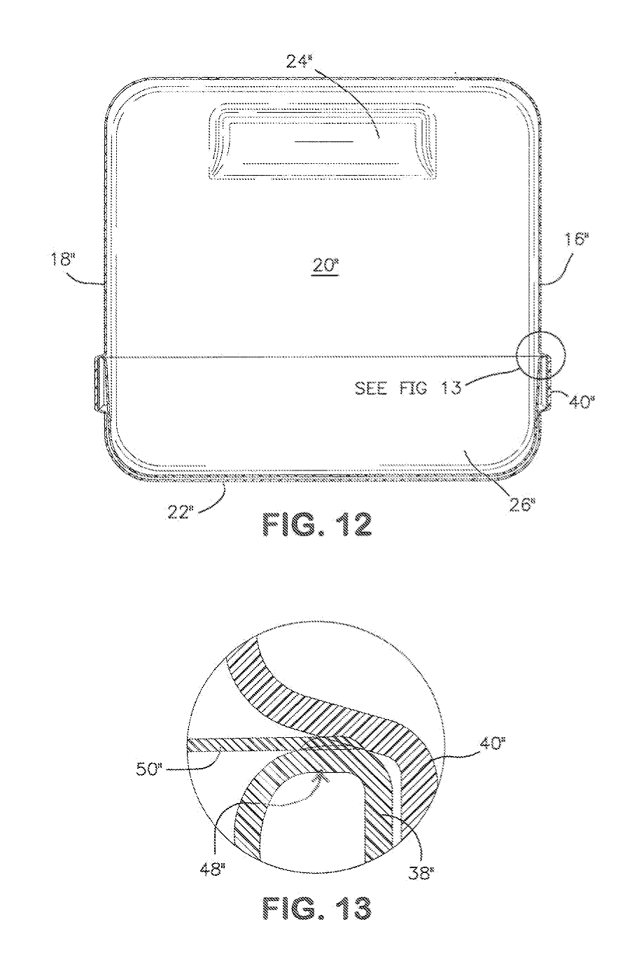

Shell 12″ includes top wall 14″, right side wall 16″, left side wall 18″, rear wall 20″ and bottom wall 22″. Handgrip recess 24″ may be formed in an upper portion of rear wall 20″, to facilitate handling of pet litter box 10″. In a preferred embodiment of the invention, shell 12″ is provided with groove 40″, which projects outwardly from side walls 16″ and 18″, as well as from back wall 20″. The interface between groove 40″ and the top edge of shoulder 38″ of drawer 26″ is shown in further detail in FIG. 13, which is an enlargement of the circled portion 13 of FIG. 12.

Drawer 26″ includes front wall 28″, right wall 30″, left wall 32″, rear wall 34″ and bottom wall 36″. Shoulder 38″, in an embodiment of the invention, shown in FIG. 10 extends around the entire upper periphery of drawer 26″.

Shoulder 38″ is configured to mate with groove 40″ disposed in drawer 26″, to create a guide structure, to facilitate the insertion and withdrawal of drawer 26″.

In the preferred embodiments of the invention, as shown in FIGS. 1 and 7, the corners where bottom wall 36″ meets with front wall 28″, right wall 30″, left wall 32″ and rear wall 34″ are rounded, to facilitate cleaning.

In the embodiment of FIGS. 10-13, as in the previously-described and illustrated embodiments, both shell 12″ and drawer 26″ are preferably fabricated from a harder plastic material such as polypropylene (“PP”). To help prevent the migration of pet litter material up over the top edge 48″ of shoulder 38″ of drawer 26″, a raised bead 50″ of a second material is provided, to help close the gap between top edge 48″ and the upper inside surface of groove 40″. Bead 50″, in a preferred embodiment of the invention, will serve as a gasket member. Preferably, bead 50″ is fabricated from a material that is softer, and/or more pliable, than the material from which shell 12″ and/or drawer 26″ are fabricated. Suitable materials, from which bead 50″ may be fabricated, may include a non-phthalate polyvinylchloride (“PVC”) material or thermoplastic elastomer (“TPE”). Such materials may prompt only a slight increase in the friction encountered by a user in inserting and withdrawing drawer 26″ into and from shell 12″. By substantially spanning the vertical gap between the upper surface of top edge 48″ and the upper inside surface of groove 40″, bead 50″ will expose little or no open vertical space, that would enable grains of pet litter material to leave drawer 26″ and migrate into groove 40″, and then ultimately into the area of shell 12″ that is below drawer 26″.

The pet litter box of the present invention is believed to combine yield many advantages of a hooded litter box, such as having a cover to help contain odors, providing an enhanced visual presentation (by obscuring the contents of the litter drawer), and providing gripping structures for facilitated handling of the pet litter box, together with the advantages of an open litter box, such as a wide open frontal area and a low front threshold for facilitated access by a pet, and a removable drawer for facilitated cleaning thereof. Furthermore, the absence of any front wall to the litter box (except for the relatively low front wall of the drawer itself), presents less of a closed-in, confined feeling for pets that may be sensitive to such issues.

The foregoing description and drawings merely explain and illustrate the invention, and the invention is not limited thereto, except as those skilled in the art who have the present disclosure before them will be able to make modifications and variations therein without departing from the scope of the invention.

1. A pet litter box comprising:
a shell, having
a top wall, the top wall having a front edge region, a rear edge region and opposing side edge regions;
a bottom wall disposed opposite the top wall, the bottom wall having a front edge region, a rear edge region and opposing side edge regions;
two opposing side walls, extending between the top wall and the bottom wall, each side wall having a top edge region and a bottom edge region, a front edge region and a rear edge region,
each of the opposing side walls of the shell being connected to a side edge region of the top wall of the shell and a side edge region of the bottom wall of the shell, respectively,
each side wall of the shell further having a rear edge region; and
a rear wall, having four side edge regions, each side edge region of the rear wall of the shell being connected to one of the rear edge region of the top wall of the shell, the rear edge region of the bottom wall of the shell, and the rear edge regions of the opposing side walls of the shell, respectively;
the shell further having litter drawer guide grooves formed in at least opposing portions of the bottom side edge regions of the opposing side walls of the shell;
and
a litter drawer, having
a front wall, the front wall having a top edge region, a bottom edge region, and opposing side edge regions;
a rear wall, the rear wall having a top edge region, a bottom edge region, and opposing side edge regions; and
two opposing side walls, each side wall having a top edge region, a bottom edge region, a front edge region and a rear edge region;
the opposing side edge regions of the front wall of the litter drawer being connected to respective ones of the front edge regions of the two opposing side walls of the litter drawer;
the opposing side edge regions of the rear wall of the litter drawer being connected to respective ones of the rear edge regions of the two opposing side walls of the litter drawer;
a bottom wall, the bottom wall having a front edge region, a rear edge region and two opposing side edge regions, the front edge region of the bottom wall of the litter drawer being connected to the bottom edge region of the front wall of the litter drawer, the rear edge region of the bottom wall of the litter drawer being connected to the bottom edge region of the rear wall of the litter drawer, and the opposing side edge regions of the bottom wall of the litter drawer being connected to respective ones of the bottom edge regions of the opposing side walls of the litter drawer;
the litter drawer further having litter drawer guide shoulders, extending outwardly from at least the top edge regions of the two opposing side walls of the litter drawer,
the litter drawer guide shoulders being operably configured to be insertingly received by respective ones of the litter drawer guide grooves of the shell, to enable the litter drawer to be selectively inserted into, retained in, and slidingly withdrawn from, the shell in a guided and stabilized manner.

2. The pet litter box according to claim 1, wherein the shell further has a litter guide groove formed in the bottom edge region of the rear wall of the shell, and the litter drawer further has a litter drawer guide shoulder formed in a top edge region of the rear wall of the litter drawer.

3. The pet litter box according to claim 1, further comprising an inwardly projecting handgrip recess formed in the top edge region of the rear wall of the shell.

4. The pet litter box according to claim 1, wherein the shell is monolithically formed from a single piece of material.

5. The pet litter box according to claim 1, wherein the litter drawer is monolithically formed from a single piece of material.

6. The pet litter box according to claim 1, wherein
the top wall, the bottom wall, and the two opposing side walls of the shell are each substantially planar, respectively; and
the top wall and the bottom wall of the shell converge toward one another, so that the rear edge regions of the top wall and the bottom wall of the shell, respectively, are closer together than the front edge regions of the top wall and the bottom wall of the shell, respectively, and
the two opposing side walls of the shell converge toward one another, so that the rear edge regions of the two opposing side walls of the shell are closer together than the front edge regions of the two opposing side walls of the shell.

7. The pet litter box according to claim 1, wherein the connections between the front, rear and side wall bottom edge regions of the respective front, rear and side walls of the litter drawer, and the respective side edge regions of the bottom wall of the litter drawer, are rounded, to facilitate cleaning of the litter drawer.

8. The pet litter box according to claim 1, further comprising:
a collar projecting outwardly from, and extending along, the front edge regions of the top wall, bottom wall, and opposing side walls of the shell,
the collar serving to elevate the front edge regions of the top wall, bottom wall, and opposing side walls of the shell, relative to the rear edge regions of the top wall, bottom wall, and opposing side walls of the shell, when the shell is resting on a flat surface.

9. The pet litter box according to claim 1,
a gasket member disposed along the top edge regions of at least the two opposing side walls of the litter drawer, the gasket member extending substantially completely from the top edge regions of the at least two opposing side walls of the litter drawer upwardly to inside surfaces of upper edge regions of the litter drawer guide grooves formed in the at least opposing portions of the bottom side edge regions of the opposing side walls of the shell.

10. The pet litter box according to claim 9, wherein the litter drawer is fabricated from a first material, and the gasket member is fabricated from a second material affixed to the top edge regions of the opposing side walls of the litter drawer.

11. The pet litter box according to claim 10, wherein the litter drawer is fabricated from a first material having a first hardness, and the gasket member is fabricated from a second material having a second hardness which is softer than the hardness of the first material of the litter drawer.

12. The pet litter box according to claim 10, wherein the shell is fabricated from a first material having a first hardness, and the gasket member is fabricated from a second material having a second hardness which is softer than the hardness of the first material of the shell.

13. The pet litter box according to claim 10, wherein the gasket member is overmolded onto the litter drawer.

14. The pet litter box according to claim 10, wherein the litter drawer is fabricated from polypropylene and the gasket member is fabricated from one of: a non-phthalate polyvinylchloride material, a thermoplastic elastomer.
